(19) United States
(12) Patent Application Publication
(10) Pub. No.: US 2002/0126436 A1
(43) Pub. Date: Sep. 12, 2002

(54) Temporary lightening protection device for a sailboat

(76) Inventors: Christian Laferriere, Gatineau (CA); Pierre Seynett, St- Lambert (CA)

Correspondence Address: Walter W. Duft, 10255 Main Street, Suite 10, 295 Main Street, Clarence, NY, 14203, US

(21) Appl. No.: 09/765,073

(22) Filed: Jan. 18, 2001

(30) Foreign Application Priority Data
Jan. 21, 2000 (CA) 2,294,493

(51) Int. Cl. H02H 1/04

(52) U.S. Cl. 361/217; 361/212; 361/220; 361/117

(57) ABSTRACT

The present invention improves on prior art apparatus and method primarily intended as lightning protection systems to be used on sailboats, particularly non-metallic hulled sailboats having one or more electrically conductive masts, by providing a temporary, easily installed electrically conductive clamping device which attaches to an electrically conductive mast in such a fashion as to not require any mechanical modification to the mast or any of its parts generally but not exclusively, in the form of machining, drilling, tapping, grinding or cutting. In the preferred embodiment, the temporary lightning protection device is comprised of at least one electrically conductive contact plate sufficiently large to offer an appropriate electrically conductive contact surface, held together on the mast generally but not exclusively by a flexible clamping device and holding straps. In the preferred embodiment, two contact plates generally run longitudinally but not exclusively to the mast, are electrically connected to submerged electrically conductive energy dissipation devices through electrically conductive cables and fittings. The purpose of this system is to provide a temporary, easily installed ad removed lightning protection system requiring no temporary or permanent modification to any parts of the mast or sailboat, no specialized labor to install and that when used will substantially reduce the risk of damages and bodily harm from a lightning strike by creating a direct pathway for the substantial energy from the lightning strike to the water or <<to ground>> thus bypassing the sailboat's living quarters and the inside of the sailboat.

### PRIOR ART

Lightning conceivably may have provided humankind with a first source of fire, but lightning has otherwise been a destructive force throughout human history. Strategies and apparatus for reducing the likelihood of damage by lightning are fairly old, including, for instance, lightning rods that have been used for approximately 200 years. While the use of such devices and other precautionary steps reduce the damage and injury that would otherwise result from lightning today, it remains an enormously dangerous natural phenomenon that claims hundreds of lives worldwide every year and destroys a substantial amount of property. This phenomenon is of especially great concern to people on sailboats as lightning protection systems are ineffective, insufficient or nonexistent on most commercially available sailboats. Whenever lightning strikes a sailboat, an enormous amount of damage is created. Typically, the lightning destroys the mast and side flashes inside the cabin breach the hull and persons aboard are seriously injured or killed. Repair efforts to the sailboat are often time consuming and expensive. Typically, complete replacement of the mast and electronic equipment is required, extensive repairs to the hull are required and occasionally the vessel is a complete write-off. As such, it is very important to develop a high capacity device that can quickly be attached to the mast, without requiring any specialized labor or temporary or permanent modification to the sailboat mast, to effectively transport the high energy delivered by a lightning strike and effectively ground it in a direct line to the water thus bypassing the cabin compartment. Unfortunately, most sailboat manufacturers today do not install lightning protection systems on their sailboats or if they do it is marginally adequate or completely inadequate to dissipate a high-energy lightning current. Most sailboat owners never have their sailboats retrofitted to higher lightning protection standards due to high cost or are simply misled in believing that current standards are sufficient to protect them during a lightning storm. The inefficiency of the current standards is amply documented in scientific research available such as a paper writtenby Ewen M. Thomson M.Sc. Ph.D., a member of the Institute of Electrical and Electronics Engineers and entitled “A Critical Assessment of the U.S. Code for Lightning Protection of Boats” published in: “IEEE Transactions on Electromagnetic compatibility, vd.33, No.2, May 1991”.

### DESCRIPTION OF PRIOR ART

A Prior art temporary lightning protection system or assembly for sailing vessels is connected to an electrically conductive mast by means of a permanently installed connection bar or stud requiring permanent modifications to the said vessel's mast by skilled persons. An example of this prior art system is: German Patent DE3817073A1 to Rietzscher & Reinhold issued Dec. 12, 1988, which discloses a temporary lightning protection system for a sailing vessel requiring the permanent installation of one or more connection studs to the mast by drilling and bolting it. The lightning protection system described hereunder, requiring no temporary or permanent modifications to the mast or any part thereof is believed to overcome the costly and irreversible disadvantage of the prior system while affording an electrically efficient connection to ground.

### DESCRIPTION

The invention relates to sailboats and more particularly, but not exclusively, to non-metallic hulled sailboats with electrically conductive masts.

The invention also relates to a lightning protection system for sailboats and more particularly, but not exclusively, a temporary lightning protection system.

It is the object of the invention to improve the safety of sailboats generally. More particularly, it is an object of the invention to improve the safety of sailboats in the event of lightning strikes.

It is the object of the invention to offer a lightning protection system to protect sailboats either not equipped or insufficiently equipped with any factory lightning protection system generally. More particularly, it is an object of the invention to offer a convenient temporary lightning protection system to sailboats, the installation of which requires no temporary or permanent modification to the existing vessel or any of its parts.

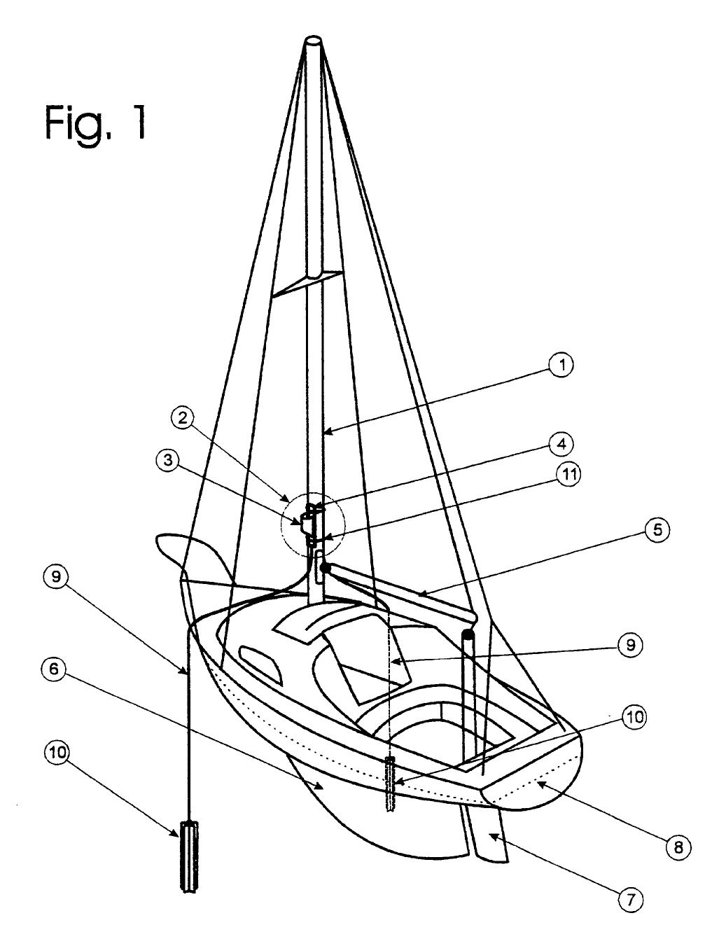

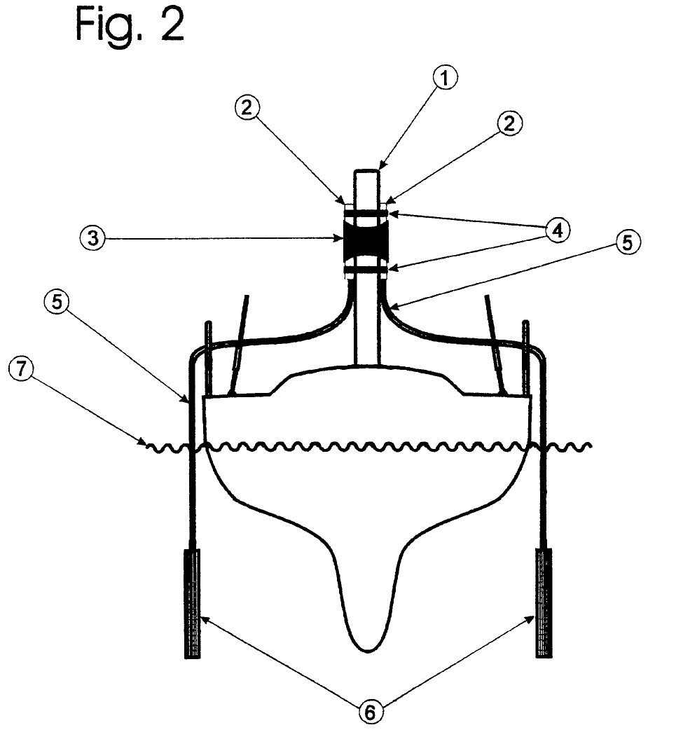

According to the invention, a sailboat has one or more electrically conductive masts upon which one or more electrically conductive plates (FIG. 1) are attached in such a fashion as to ensure an electrically conductive connection. The contact plate(s) and clamp assembly (FIGS. 1-2) is/are also electrically connected to electrically conductive insulated cables (FIGS. 1-9) which are also electrically connected to an energy dissipation device (FIGS. 1-10) which hangs overboard and sufficiently deep below the surface (FIGS. 1-8), to ensure an electrically conductive lightning protection system in the event of a lightning strike hitting the sailboat mast or any part thereof.

Preferably, the contact plates and the clamping/holding configuration is in a form capable of quickly attaching itself by positive clamping pressure in such a manner as to ensure a solid electrically conductive connection to all types of masts without requiring any temporary or permanent modification to the mast or any part thereof.

Preferably, the electrical conductors that connect the clamp to the energy dissipation devices are insulated and capable of conducting very high levels of electrical energy without being destroyed or causing large amounts of impedance, which can lead to side flashing.

Preferably, the energy dissipation devices are large enough and their geometry is such that they offer a lower electrical resistance, creating a larger breakdown electrical field, initiating small sparks or electrical streamers at the lowest possible impulse crest voltage thus reducing the risk of dangerous side flashes of lightning. The energy dissipation device generally has but not exclusively, a polygonal cross section offering a maximum number of protruding edges for proper energy dissipation.

Preferably, the mast of the vessel is of aluminum or a similar electrically conductive metal.

The invention is diagrammatically illustrated, by way of example, in the accompanying drawings in which

FIG. 1 is a perspective representation of a typical sailboat.

FIG. 2 is a sectional end view of the sailboat.

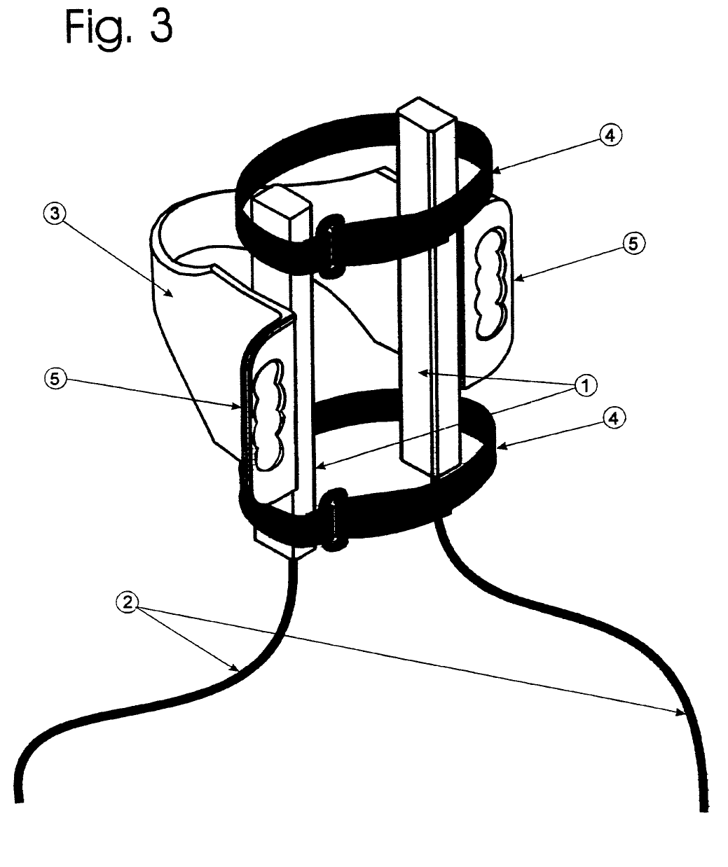

FIG. 3 is a perspective representation of the aforementioned contact plates/mast clamp with electrical cables.

In FIG. 1 drawings there is shown a sailboat having a mast (1) of aluminum or similar electrically conductive metal extrusion on which is articulated a boom (5) for controlling a sail (not shown). In generally conventional fashion, the hull is formed with a downwardly deepening keel (6) and a steering rudder (7) for use in maneuvering the vessel in harbor and other confined spaces. The normal waterline of the sailboat is shown by dotted line (8).

Attached to the mast is an electrically conductive grounding clamp (2) composed of contact plates (4), a clamping jaw (3) and cinching straps (4) to which electrically conductive cables (9) and energy dissipation devices (10) are connected. The energy dissipation devices (10) are well below the waterline (8) in order to offer proper dissipation of the high energy delivered by a lightning strike.

In FIG. 2 drawings, there is shown a sailboat cross-section having a mast (1) to which are attached two electrically conductive contact plates (2) on either side of the mast (1) by means of a “C” shaped clamping device (3) additionally supported by holding straps (4). The contact plates (2) are thence connected to electrical cables (5) that are also electrically connected to submerged energy dissipation devices (6) that are placed substantially below the vessel's normal waterline (7) for proper dissipation of lightning energy traveling down the mast (1) during a lightning strike.

In FIG. 3 drawings, there is shown a perspective representation of the aforementioned mast clamp consisting of two electrically conductive contact plates (1) held together by a “C” shaped clamping device (3) with handles (5) for easy installation and connected to electrically conductive electrical cables (2). The clamping force of the device is further enhanced by the use of cinching straps (4) that offer positive tension thus ensuring positive gripping on any type of electrically conductive sailboat mast.

The invention thus provides a simple, temporary and effective means for attaching an electrically inductive lightning protection system to a sailboat mast thus mitigating the risk of damages caused by the effects of lightning strikes.

The embodiments of the present invention in which an exclusive property or privilege is claimed are defined as follows:

1. A temporary lightning protection system characterized in that it consists of a clamping/holding system holding at least one electrically conductive contact plate tightly against an electrically conductive sailboat mast, with the contact plate(s) being electrically connected to electrical conductors also electrically connected to submerged energy dissipation devices that extend substantially below the waterline of the hull of a sailboat.

2. A temporary lightning protection system characterized in that it consists of at least one electrically conductive mast clamp comprised of at least one contact plate to which is electrically connected one or more electrical conductor(s) also electrically connected to one or more energy dissipation devices.

3. A temporary lightning protection system according to any preceding claim, characterized in that the contact plate(s), clamping/holding system, or any of its parts are detachable from the mast for storage when not in use.

4. A temporary lightning protection system according to any preceding claim, characterized in that the contact plate(s), clamping/holding system or any of its parts, in order to function as designed, require no temporary or permanent modification, generally but not exclusively in the form of drilling, tapping, machining, grinding, cutting to any existing part of the sailboat.

5. A temporary lightning protection system according to any preceding claim, characterized in that the contact plate(s), clamping/holding system or any of its parts, in order to function as designed, require no specialized labor to install.
